(19) United States
(12) Patent Application Publication
(10) Pub. No.: US 2023/0140480 A1
(43) Pub. Date: May 4, 2023

(54) UTTERANCE GENERATION APPARATUS, UTTERANCE GENERATION METHOD, AND PROGRAM

(71) Applicant: NIPPON TELEGRAPH AND TELEPHONE CORPORATION, Tokyo (JP)

(72) Inventors: Hiromi NARIMATSU, Tokyo (JP); Hiroaki SUGIYAMA, Tokyo (JP); Masahiro MIZUKAMI, Tokyo (JP); Tsunehiro ARIMOTO, Tokyo (JP)

(73) Assignee: NIPPON TELEGRAPH AND TELEPHONE CORPORATION, Tokyo (JP)

(21) Appl. No.: 17/911,627

(22) PCT Filed: Mar. 17, 2020
(86) PCT No.: PCT/JP2020/011614

§ 371 Date: Sep. 14, 2022

(51) Int. Cl. G06F 40/289; G06F 40/35

(52) U.S. Cl. CPC G06F 40/289; G06F 40/35

(57) ABSTRACT

Provided is a technique for generating an utterance based on data indicating the context of a dialogue. The technique includes: a phrase extracting unit for generating a phrase set as a set of elements, in which data includes pairs of context items and the values of the context items to be extracted from an input text indicating an utterance of a user; a context-understanding-result updating unit for generating, by using the phrase set, an updated context understanding result indicating the context of the latest dialogue from a pre-update context understanding result indicating the context of the current dialogue; a dialogue control unit for selecting data on an experience class as a similar experience based on a degree of similarity calculated between the updated context understanding result and data on the experience class included in an experience database, and selecting, as an utterance template candidate, data on an utterance template class from an utterance template database by using the pre-update context understanding result and the updated context understanding result; and an utterance generating unit for generating an output text, which serves as a response to the input text, by using the updated context understanding result, the similar experience, and the utterance template candidate.

### TECHNICAL FIELD

The present invention relates to a technique for generating an utterance.

### BACKGROUND ART

Systems for dialogues with users are currently under intensive study. For example, a method describe in NPL 1 enables dialogues between a user and a system by extensive learning of pairs of utterances and responses. Unfortunately, this method may cause the system to return a slightly unnatural response, making the user feel that the system does not understand the dialogue.

Thus, a method of “repeating a part of a preceding user's utterance” may be used to indicate that a system understands the user's utterance (NPL 2). This method imitates a method used in human communications, and the effectiveness is already known (NPL 3).

### CITATION LIST

### Non Patent Literature

[NPL 1] Toyomi Meguro, Hiroaki Sugiyama, Ryuichiro Higashinaka, and Yasuhiro Minami, “Building a conversational system based on the fusion of rule-based and stochastic utterance generation,” The 28th Annual Conference of the Japanese Society for Artificial Intelligence, The Japanese Society for Artificial Intelligence, 2014.
[NPL 2] Ryuichiro Higashinaka, Kohji Dohsaka, and Hideki Isozaki, “Effects of self-disclosure and empathy in human-computer dialogue,”2008 IEEE Spoken Language Technology Workshop, IEEE, 2008.
[NPL 3] Tatsuya Kawahara, “Spoken dialogue system for a human-like conversational robot ERICA,” 9th International Workshop on Spoken Dialogue System Technology, Springer, Singapore, 2019.

### SUMMARY OF THE INVENTION

### Technical Problem

The method described in NPL 2 is surely an effective method for indicating understanding by the system to a user. Unfortunately, there is a problem that this method may pick up a part of improper utterance. In this case, the user may have an impression that “the system does not understand the dialogue.” Moreover, in this method, the system does not understand the context and thus may return a response that does not reflect the contents of an utterance before the preceding utterance.

An object of the present invention is to provide a technique of generating data on the context of a dialogue and generating an utterance based on data indicating the context of the dialogue.

### Means for Solving the Problem

An aspect of the present invention in which a context class is a data structure including an experience period as an item indicating the period of an experience, an experience location as an item indicating the location of an experience, an experienced person as an item indicating a person who shares an experience, experience contents as an item indicating the contents of an experience, and an experience impression as an item indicating an impression about an experience, an experience class is a data structure including an experience period, an experience location, an experienced person, experience contents, and an experience impression, which are items included in the context class (hereinafter referred to as context items), and an experience impression reason as an item indicating grounds for an impression about an experience, and an utterance template class is a data structure including information (hereinafter referred to as a template ID) for identifying a template (hereinafter referred to as an utterance template) used for generating an utterance, the utterance template, an utterance category indicating the type of the utterance template, and a context item indicating the focus of the utterance template (hereinafter referred to as a focus item), the aspect including: a recording unit for recording an experience database including data on the experience class and an utterance template database including data on the utterance template class; a phrase extracting unit for generating a phrase set as a set of elements, in which data includes pairs of context items and values of the context items (hereinafter referred to as phrases) to be extracted from an input text indicating an utterance of a user; a context-understanding-result updating unit for generating, by using the phrase set, data on a context class indicating the context of the latest dialogue (hereinafter referred to as an updated context understanding result) from data on a context class indicating the context of the current dialogue (hereinafter referred to as a pre-update context understanding result); a dialogue control unit for selecting data on at least one experience class as a similar experience based on a degree of similarity calculated between the updated context understanding result and data on the experience class included in the experience database, and selecting, as an utterance template candidate, data on the utterance template class from the utterance template database by using the pre-update context understanding result and the updated context understanding result; and an utterance generating unit for generating an output text, which indicates an utterance serving as a response to the input text, by using the updated context understanding result, the similar experience, and the utterance template candidate.

### Effects of the Invention

According to the present invention, an utterance can be generated based on data indicating the context of a dialogue.

### BRIEF DESCRIPTION OF DRAWINGS

FIG. 1 indicates an example of a dialogue in a conventional dialogue system.

FIG. 2 indicates an example of a desired dialogue in a dialogue system according to the invention of the present application.

FIG. 3 is an explanatory drawing illustrating an approach of the invention of the present application.

FIG. 4 is an explanatory drawing illustrating an approach of the invention of the present application.

FIG. 5 indicates an example of an utterance template.

FIG. 6 is a block diagram illustrating the configuration of an utterance generator 100.

FIG. 7 is a flowchart indicating the operations of the utterance generator 100.

FIG. 8 indicates an example of a context understanding result.

FIG. 9 is an explanatory drawing of a degree of similarity.

FIG. 10 indicates an example of an updated context understanding result and a similar experience that are used when an utterance is generated from the utterance template.

FIG. 11 indicates an example of an updated context understanding result and a similar experience that are used when an utterance is generated from the utterance template.

FIG. 12 illustrates an example of the functional configuration of a computer for implementing devices according to an embodiment of the present invention.

### DESCRIPTION OF EMBODIMENTS

An embodiment of the present invention will be specifically described below. Components having the same functions are indicated by the same numbers and a redundant explanation is omitted.

Prior to a description of each embodiment, notations in the present specification will be described below.

Λ(caret) indicates a superscript. For example, xY^{Λz} means that y^{z} is the superscript of x while x_{yΛz} means that y^{z} is the subscript of x. Furthermore, (underscore) indicates a subscript. For example, x^{Y_z} means that y_{z} is the superscript of x while X_{y_z} means that y_{z} is the subscript of x.

Superscripts “Λ” and “˜” of, for example, ^{Λ}x and ^{˜}x should be normally indicated directly above “x” but letter x is denoted as ^{Λ}x and ^{˜}x because of the limited notations in the description of the specification.

### BACKGROUND ART

In the following example, a process in which a user becomes suspicious about the dialogue capability of a conventional dialogue system during a dialogue in the dialogue system will be described below. Subsequently, an example of a desired dialogue in a dialogue system according to the invention of the present application will be discussed, and an approach to implementing the dialogue will be discussed later.

### Dialogue Example in a Conventional Dialogue System

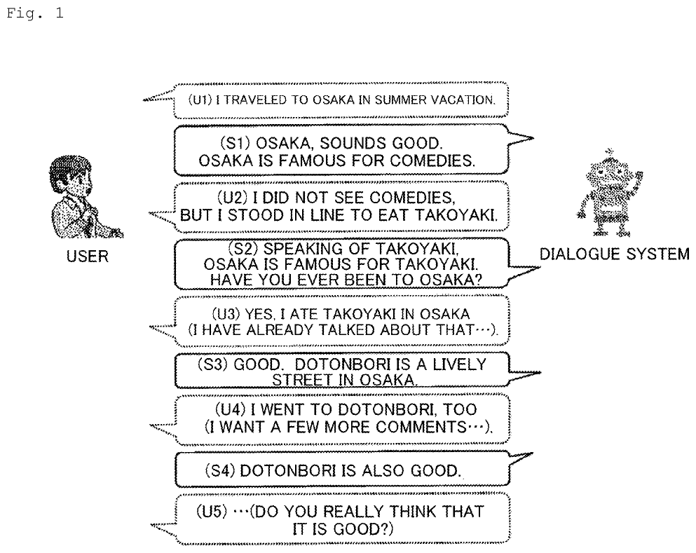

FIG. 1 indicates a dialogue example in a chat system in the form of questions and answers. In FIG. 1, for convenience, the utterances of a user are denoted as U1, U2, . . . while the utterances of a dialogue system are denoted as S1, S2,. . . . Moreover, brackets in the utterances of the user describe what is on the user's mind.

In the dialogue of FIG. 1, the dialogue system uttered “Speaking of takoyaki, ball-shaped pancake containing small pieces of octopus, Osaka is famous for takoyaki. Have you ever been to Osaka?” in S2. However, the user uttered “I traveled to Osaka in the summer vacation.” in U1. This indicates that the dialogue system asked a question about the contents that had been already mentioned, making the user feel suspicious about the power of understanding of the dialogue system.

In S3, the dialogue system utters “Good. Dotonbori is a lively street in Osaka.”, suddenly changing the topic to Dotonbori. This indicates that the dialogue system returns an unnatural response in the context at that point, though the topic is takoyaki, making the user feel suspicious about the power of understanding of the dialogue system.

Furthermore, in S4, the dialogue system utters “Dotonbori is also good.” without presenting any particular reasons. Thus, the user feels that the dialogue system may be out of sympathy with the user, so that the user is finally discouraged from talking to the system.

In the dialogue, the dialogue system repeats utterances without understanding the context, leading to a question about the contents that have been already mentioned and an unnatural utterance out of context. Thus, the user feels that the dialogue system does not have dialogue capability, reducing the reliability of the utterance of the dialogue system.

(Example of a desired dialogue in the dialogue system according to the invention of the present application)

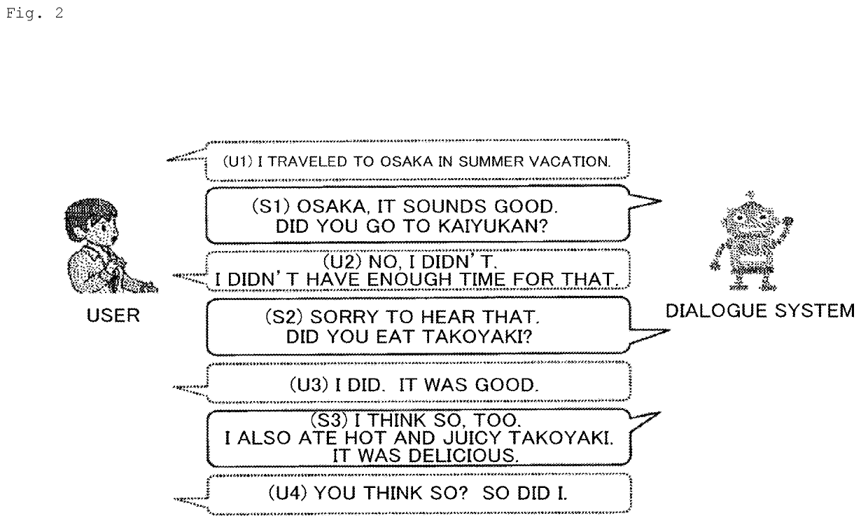

FIG. 2 indicates an example of a desired dialogue in the dialogue system according to the invention of the present application. In FIG. 2, for convenience, the utterances of the user are denoted as U1, U2, . . . while the utterances of the dialogue system are denoted as S1, S2, . . . as in FIG. 1.

In the dialogue of FIG. 2, the dialogue system utters “Osaka. Sounds good. Did you go to Kaiyukan (aquarium)?” in S1. The dialogue system makes an appropriate response and then asks a question about a specific tourist facility in the context.

Furthermore, the dialogue system utters “I regret to hear that you could not go there. Did you eat takoyaki?” in S2, which focuses on a topic following the context.

Moreover, in S3, the dialogue system utters “Good. I also ate hot and juicy takoyaki. It was delicious.” The dialogue system utters with sympathy, so that the user feels as if the feeling was understood by the dialogue system.

In the dialogue, the dialogue system utters according to the context, so that the user feels as if the utterance was made in context with the feeling of the user or the feeling was understood by the dialogue system throughout the dialogue.

### Approach to the Invention of the Present Application

The invention of the present application adopts an approach that utters with sympathy or asks a question according to the context by understanding the context of a dialogue with a structure of “when,” “where,” “with whom,” “what,” and “impression” and using a database (hereinafter referred to as an experience database) on experiences structured to include the structure. The approach will be described below with reference to the accompanying drawings.

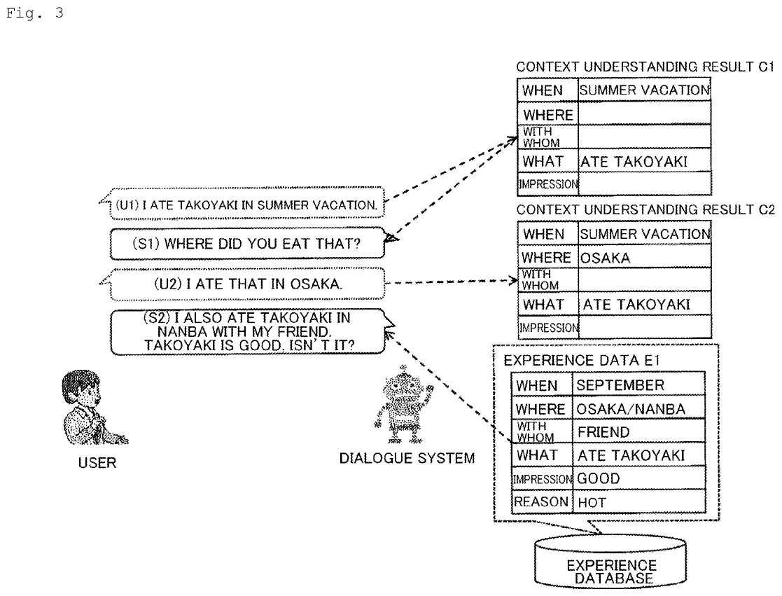

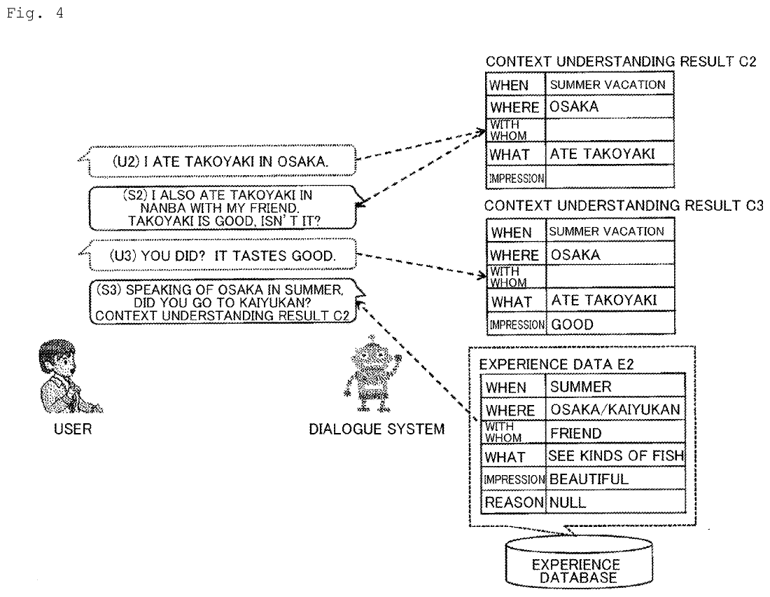

FIGS. 3 and 4 indicate the process of understanding of a context by the dialogue system and the resultant utterance in a dialogue. In FIGS. 3 and 4, for convenience, the utterances of a user are denoted as U1, U2, . . . while the utterances of a dialogue system are denoted as S1, S2, . . . . Moreover, in FIGS. 3 and 4, contexts understood by the dialogue system (hereinafter referred to as context understanding results) are denoted as C1, C2, . . . while data on experiences (hereinafter referred to as experience data) is denoted as E1, E2, . . . .

In the dialogue of FIG. 3, the user utters “I ate takoyaki in the summer vacation.” in U1. For U1, the dialogue system understands the utterance as the context understanding result C1. The dialogue system then utters “Where did you eat takoyaki?” in S1 because an item “where” in the context understanding result C1 is vacant.

The user then utters “I ate takoyaki in Osaka.” in U2 that is a response to S1. The dialogue system understands the additional utterance U2 from the user as the context understanding result C2 based on the context understanding result C1. The dialogue system then acquires the experience data E1, which is similar to the context understanding result C2, as a search result by using an experience database, and utters “I also ate takoyaki in Nanba with my friend. Takoyaki is good, isn't it?” in S2, which indicates experience-based sympathy to the user.

Moreover, in the dialogue of FIG. 4, the user utters “You did? It tastes good.” in U3 in response to the utterance S2 by the dialogue system. The dialogue system understands the additional utterance U3 from the user as the context understanding result C3 based on the context understanding result C2. The dialogue system then acquires the experience data E2, which is similar to the context understanding result C3, as a search result by using the experience database, and utters “Speaking of Osaka in summer, did you go to Kaiyukan?” in S3, which is a question to the user in the context of “summer” and “Osaka.”

### First Embodiment

An utterance generator 100 generates an utterance as a response to a user's utterance in a dialogue. At this point, in order to understand a context that is the flow of the dialogue with the user, the utterance generator 100 generates, by using a data structure called a context class, a context understanding result that is data on the context class. In this case, the context class is a data structure including an experience period as an item indicating the period of an experience, an experience location as an item indicating the location of an experience, an experienced person as an item indicating a person who shares an experience, experience contents as an item indicating the contents of an experience, and an experience impression as an item indicating an impression about an experience. An experience period, an experience location, an experienced person, experience contents, and an experience impression correspond to the respective five items, that is, “when,” “where,” “with whom,” “what,” and “impression” in <Background Art>.

Moreover, the utterance generator 100 uses the experience database to generate an utterance as if an experience was actually gained or reported. In this case, the experience database is a database including data on an experience class. The experience class is a data structure including an experience period, an experience location, an experienced person, experience contents, and an experience impression, which are items included in the context class (hereinafter referred to as context items), and an experience impression reason as an item indicating grounds for an impression about an experience.

The utterance generator 100 uses an utterance template database to generate an utterance. The utterance template is a template serving as an utterance pattern. The utterance template database is a database including data on an utterance template class. The utterance template class is a data structure including information for identifying an utterance template (hereinafter referred to as a template ID), the utterance template, an utterance category indicating the type of the utterance template, and a context item indicating the focus of the utterance template (hereinafter referred to as a focus item).

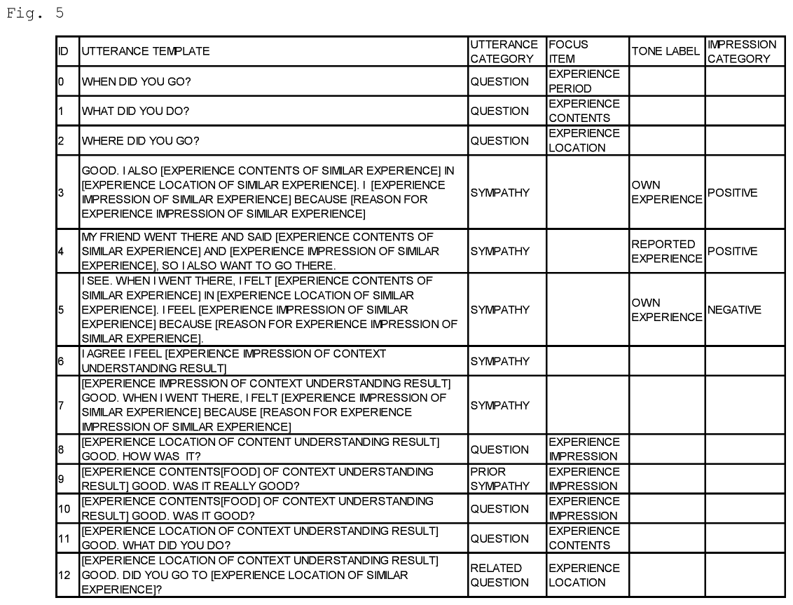

FIG. 5 illustrates an example of the utterance template database. In this example, a template ID is simply abbreviated as an ID. The utterance template class of FIG. 5 includes a tone label that indicates the tone of an utterance template and an impression category that indicates the type of an impression, in addition to a template ID, an utterance template, an utterance category, and a focus item.

The values of the utterance category include a question, prior sympathy, a related question, and sympathy. The prior sympathy is an utterance for indicating sympathy to a user in advance in order to utter based on an experience in a next utterance when having an experience similar to a user's experience. The experience similar to a user's experience means a similar experience with a degree of similarity higher than or equal to a predetermined threshold.

If the value of the database utterance category is a related question or sympathy, the utterance template has supplementary fields for at least one context item. In the supplementary fields for the experience period of a similar experience, the experience location of a similar experience, a person who has experienced a similar experience, the experience contents of a similar experience, the experience impression of a similar experience, and the reason for the experience impression of a similar experience, the values of an experience period, an experience location, an experienced person, experience contents, an experience impression, and the reason for an experience impression in a similar experience are set when an utterance is generated from the utterance template. In the supplementary fields for the experience period of a context understanding result, the experience location of a context understanding result, a person who has experienced of a context understanding result, the experience contents of a context understanding result, and the experience impression of a context understanding result, the values of an experience period, an experience location, an experienced person, experience contents, an experience impression, and the reason for an experience impression in a context understanding result are set when an utterance is generated from the utterance template.

For example, an utterance template with a template ID of 3 in FIG. 5 has four supplementary fields for the experience location of a similar experience, the experience contents of a similar experience, the reason for the experience impression of a similar experience, and the experience impression of a similar experience. Moreover, an utterance template with a template ID of 7 has three supplementary fields for the experience impression of a context understanding result, the reason for the experience impression of a similar experience, and the experience impression of a similar experience.

If the value of the utterance category is a question or prior sympathy, the utterance template may have no supplementary fields for context items. In utterance templates with template IDs of 0, 1, and 2 in FIG. 5, the values of utterance categories are all questions with no supplementary fields. In utterance templates with template IDs of 8, 9, 10, and 11 in FIG. 5, the values of utterance categories are questions or prior sympathy, and each of the templates has a supplementary field.

The impression category has positive and negative values.

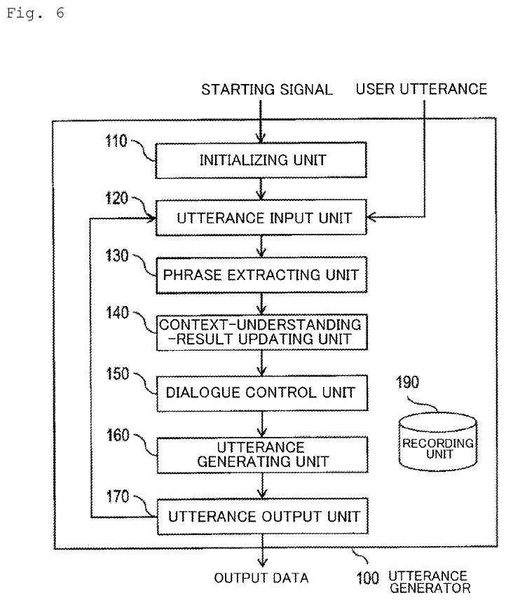

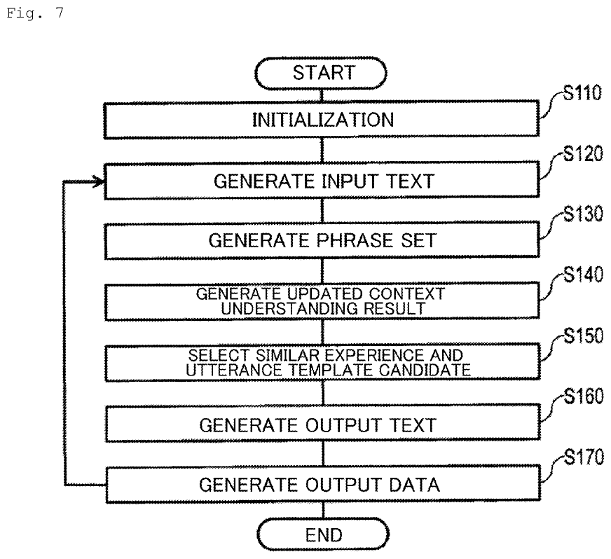

Referring to FIGS. 6 and 7, the utterance generator 100 will be described below. FIG. 6 is a block diagram illustrating the configuration of the utterance generator 100. FIG. 7 is a flowchart indicating the operations of the utterance generator 100. As illustrated in FIG. 6, the utterance generator 100 includes an initializing unit 110, an utterance input unit 120, a phrase extracting unit 130, a context-understanding-result updating unit 140, a dialogue control unit 150, an utterance generating unit 160, an utterance output unit 170, and a recording unit 190. The recording unit 190 is a component for properly recording information necessary for the processing of the utterance generator 100. The recording unit 190 records an experience database and an utterance template database in advance. The recording unit 190 may record a database (hereinafter referred to as an utterance history database) for chronologically recording an input text corresponding to a user's utterance and an output text corresponding to an utterance of the utterance generator 100, in order to record the history of dialogues with the user. When an output text is recorded in the utterance history database, a template ID used for generating the output text may be also recorded.

Referring to FIG. 7, the operations of the utterance generator 100 will be described below.

In S110, the initializing unit 110 performs initialization necessary for starting a dialogue with the user. In the initialization, a signal for starting the utterance generator 100 may be started as, for example, a cue for starting a dialogue or the first utterance by the user may be started as a cue for starting a dialogue. In the initialization, for example, a context understanding result is initialized. Specifically, the values of the context items of a context understanding result are replaced with values such as “NULL” indicating a void.

In S120, the utterance input unit 120 receives a user's utterance as an input, generates a text (hereinafter referred to as an input text), which indicates the user's utterance, from the user's utterance, and outputs the text. The user's utterance may be inputted in any data format. The user's utterance may be, for example, a text, a speech (speech signal), or binary data. If a user's utterance is inputted as a text, the utterance input unit 120 receives the text as an input text as is. If a user's utterance is inputted as a speech, the utterance input unit 120 recognizes the speech by using a predetermined speech recognition technique and generates a speech recognition result as an input text. A speech may be recognized using any technique capable of generating a text from the speech so as to correspond to the speech. If multiple candidates are obtained as speech recognition results, the utterance input unit 120 may output a list of pairs of the candidates and reliability as an input of the phrase extracting unit 130. In this case, the phrase extracting unit 130 extracts a phrase by using the most reliable candidate. If the extraction fails, the phrase extracting unit 130 extracts a phrase by using the candidate in the second place.

In S130, the phrase extracting unit 130 receives, as an input, the input text generated in S120, generates a phrase set as a set of elements, in which data includes pairs of context items and the values of the context items (hereinafter referred to as phrases) to be extracted from the input text, and outputs the phrase set. For example, in the case of an input text “I ate takoyaki in Dotonbori.”, the phrase extracting unit 130 generates {(experience location, ‘Dotonbori’), (experience contents, ‘I ate takoyaki’)} as a phrase set. In this example, the phrase includes a pair of a context item and the value of the context item, e.g., (experience contents, ‘I ate takoyaki’). The phrase may include other associated information. For example, the phrase may include a context item, the section of a character string, and the value of the context item, e.g., (experience contents, [4:11], ‘I ate takoyaki’). In this case, the section of the character string indicates a pair of the position of the first character and the position of the last character in the character string where characters included in the input text are sequentially numbered 0, 1, . . . from the beginning.

If the phrase extracting unit 130 generates a phrase set in which elements are phrases including pairs of experience impressions and the values of the experience impressions, the phrase extracting unit 130 may specify the impression category of the input text, that is, whether the impression category is positive or negative, and then output the impression category. In this case, the utterance generating unit 160 can generate a proper response (e.g., “Good” or “I see”) as an utterance based on the impression category of the input text.

In S140, the context-understanding-result updating unit 140 receives, as an input, the phrase set generated in S130, uses the phrase set to generate data on a context class indicating the context of the latest dialogue (hereinafter referred to as an updated context understanding result) from data on a context class indicating the context of the current dialogue (hereinafter referred to as a pre-update context understanding result), and outputs the generated data. At this point, the context-understanding-result updating unit 140 reads, for example, the pre-update context understanding result recorded in the recording unit 190 and writes the updated context understanding result to the recording unit 190. The updated context understanding result serves as a pre-update context understanding result during the processing of an input text generated by the utterance generator 100 subsequently to the currently processed input text.

Updating of a context understanding result will be specifically described below.

(1) The context-understanding-result updating unit 140 extracts a phrase that is an element of the phrase set.

(2) If the context item of a pre-update context understanding result corresponding to a context item included in the extracted phrase has a value indicating a void, the context-understanding-result updating unit 140 writes the value of the context item included in the phrase, as the value of the context item of an updated context understanding result. If the context item of a pre-update context understanding result corresponding to a context item included in the extracted phrase does not have a value indicating a void (that is, the value of the context item has been written), the context-understanding-result updating unit 140 writes the value of the context item included in the phrase, as an additional value of the context item of the updated context understanding result.

(3) The context data updating unit 140 repeats the processing of (1) and (2). At the completion of processing on all the elements of the phrase set, the updated context understanding result is written into the recording unit 190, so that the processing is completed.

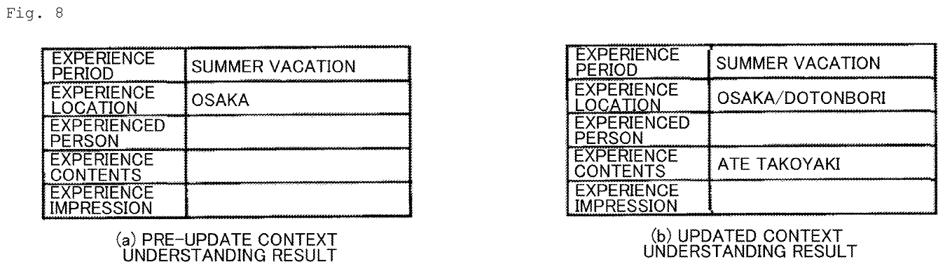

For example, if the phrase set is {(experience location, ‘Dotonbori’), (experience contents, ‘I ate takoyaki’)} and the pre-update context understanding result is data in FIG. 8(a), the context-understanding-result updating unit 140 generates the updated context understanding result of FIG. 8(b).

In S150, the dialogue control unit 150 receives, as inputs, the pre-update context understanding result recorded in the recording unit 190 and the updated context understanding result generated in S140, selects a similar experience and an utterance template candidate by using the pre-update context understanding result and the updated context understanding result, and outputs the similar experience and the utterance template candidate. Specifically, the dialogue control unit 150 selects data on at least one experience class as a similar experience based on a degree of similarity calculated between the updated context understanding result and data on an experience class included in the experience database. Furthermore, the dialogue control unit 150 selects, as an utterance template candidate, data on an utterance template class from the utterance template database by using the pre-update context understanding result and the updated context understanding result.

The selection of a similar experience and the selection of an utterance template candidate will be described below. First, the selection of a similar experience will be specifically described below.

### Method for Selecting a Similar Experience

(1) The dialogue control unit 150 extracts a piece of data on an experience class included in the experience database.

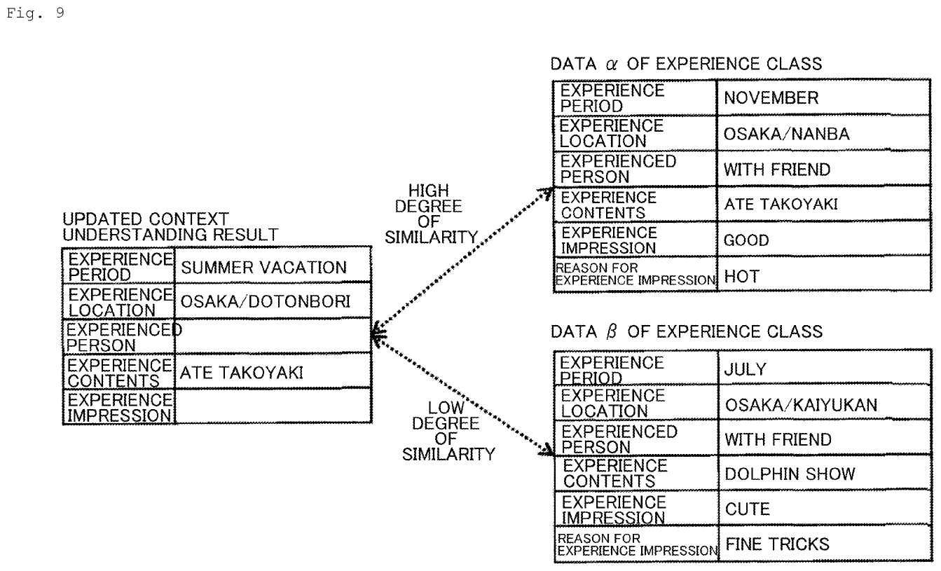

(2) The dialogue control unit 150 calculates a degree of similarity between the updated context understanding result and the extracted experience class data. The degree of similarity can be calculated based on, for example, a match rate, as character strings, for each context item between the updated context understanding result and the experience class data. The degree of similarly may be increased for experience class data including a large number context items with a match rate at a predetermine rate (e.g., 0.9) or higher (FIG. 9). A match rate for a string of morphemes may be used instead of a match rate for a character string. A match rate for a string of morphemes indicates a match rate calculated based on two strings of morphemes obtained by morphological analysis on a character string of the context items of the updated context understanding result and a character string of context items in the experience class data. A match rate for a string of morphemes is used for the following reason: in the case of character strings indicating different locations, for example, “Tokyo” and “Kyoto,” the character strings may have a high match rate, whereas the strings of morphemes have a low match rate, thereby avoiding erroneous determination. Instead of calculating match rates for all the context items, a match rate may be calculated only for two context items: an experience location and experience contents. A degree of similarity is calculated by using only the two context items of an experience location and experience contents because a location and the contents are particularly useful in examining an experience. It is assumed that an utterance based on an experience with a high degree of similarity calculated by using the two context items of an experience location and experience contents is more like to gain sympathy from a user than an utterance based on an experience with a high degree of similarity calculated by using other context items as well (that is, the user easily understands the sympathy of the system).

(3) The dialogue control unit 150 repeats the processing of (1) and (2). At the completion of processing on all of the pieces of experience class data included in the experience database, data on at least one experience class is selected and outputted as a similar experience in decreasing order of degree of similarity, and then the processing is completed. Upon the output, the dialogue control unit 150 may output the degree of similarity of a similar experience according to the similar experience.

The selection of an utterance template candidate will be described below.

### Method for Selecting an Utterance Template Candidate

(1) The dialogue control unit 150 specifies the context items of the updated context understanding result based on the pre-update context understanding result and the updated context understanding result. For example, the dialogue control unit 150 can specify the context items of the updated context understanding result by comparing the context items of the pre-update context understanding result and the updated context understanding result as character strings.

(2) The dialogue control unit 150 selects an utterance template candidate according to a method corresponding to the context items of the updated context understanding result. Some examples will be described below. In these examples, the dialogue control unit 150 determines conditions for updating the context understanding result and performs processing according to the determination result.

(2-1) In the case where the dialogue control unit 150 determines that the experience impression of the context understanding result has been updated based on the pre-update context understanding result and the updated context understanding result.

If the experience location of the updated context understanding result has a value indicating a void, the dialogue control unit 150 selects, as an utterance template candidate, data on an utterance template class including a question as an utterance category and an experience location as a focus item. If the experience contents of the updated context understanding result have a value indicating a void, the dialogue control unit 150 selects, as an utterance template candidate, data on an utterance template class including a question as an utterance category and experience contents as a focus item. If the experience location and the experience contents of the updated context understanding result do not have values indicating a void, the dialogue control unit 150 selects, as an utterance template candidate, data on an utterance template class including sympathy as an utterance category and one of an experience location and experience contents as a focus item.

If the experience location and the experience contents of the updated context understanding result do not have values indicating a void, the dialogue control unit 150 may check whether the selected utterance template candidate has been used in past utterances, according to the utterance history database. If the selected utterance template candidate has been used in past utterances, the dialogue control unit 150 may select, as an utterance template candidate, data on an utterance template class in which a question serves as an utterance category and the context item of the updated context understanding result has a value indicating a void.

(2-2) In the case where the dialogue control unit 150 determines that the experience contents of the context understanding result have been updated based on the pre-update context understanding result and the updated context understanding result.

If the degree of similarity of a similar experience is higher than or equal to the predetermined threshold, the dialogue control unit 150 selects, as an utterance template candidate, data on an utterance template class including prior sympathy as an utterance category. In other cases, the dialogue control unit 150 performs processing for the following three cases: If the experience location of the updated context understanding result has a value indicating a void, the dialogue control unit 150 selects, as an utterance template candidate, data on an utterance template class including a question as an utterance category and an experience location as a focus item. If the experience impression of the updated context understanding result has a value indicating a void, the dialogue control unit 150 selects, as an utterance template candidate, data on an utterance template class including a question as an utterance category and an experience impression as a focus item. If the experience location and the experience impression of the updated context understanding result do not have values indicating a void, the dialogue control unit 150 selects, as an utterance template candidate, data on an utterance template class including sympathy as an utterance category and one of an experience location and an experience impression as a focus item.

As in (2-1), the dialogue control unit 150 may check whether the selected utterance template candidate has been used in past utterances, according to the utterance history database.

(2-3) In the case where the dialogue control unit 150 determines that the experience location of the context understanding result has been updated based on the pre-update context understanding result and the updated context understanding result.

If the degree of similarity of a similar experience is higher than or equal to the predetermined threshold, the dialogue control unit 150 selects, as an utterance template candidate, data on an utterance template class including prior sympathy as an utterance category. In other cases, the dialogue control unit 150 performs processing for the following three cases: If the experience contents of the updated context understanding result have a value indicating a void, the dialogue control unit 150 selects, as an utterance template candidate, data on an utterance template class including a question as an utterance category and experience contents as a focus item. If the experience impression of the updated context understanding result has a value indicating a void, the dialogue control unit 150 selects, as an utterance template candidate, data on an utterance template class including a question as an utterance category and an experience impression as a focus item. If the experience contents and the experience impression of the updated context understanding result do not have values indicating a void, the dialogue control unit 150 selects, as an utterance template candidate, data on an utterance template class including sympathy as an utterance category and one of experience contents and an experience impression as a focus item.

As in (2-1), the dialogue control unit 150 may check whether the selected utterance template candidate has been used in past utterances, according to the utterance history database.

(2-4) In the case where The dialogue control unit 150 determines that the experience period of the context understanding result has been updated based on the pre-update context understanding result and the updated context understanding result.

If the experience location and the experience contents of the updated context understanding result do not have values indicating a void, the dialogue control unit 150 selects, as an utterance template candidate, data on an utterance template class including a question as an utterance category and an experience period and an experience impression as focus items. If the experience location of the updated context understanding result has a value indicating a void, the dialogue control unit 150 selects, as an utterance template candidate, data on an utterance template class including a related question as an utterance category and an experience location as a focus item. If the experience contents of the updated context understanding result have a value indicating a void, the dialogue control unit 150 selects, as an utterance template candidate, data on an utterance template class including a related question as an utterance category and experience contents as a focus item.

As in (2-1), the dialogue control unit 150 may check whether the selected utterance template candidate has been used in past utterances, according to the utterance history database.

(2-5) In the case where the dialogue control unit 150 determines that the experienced person of the context understanding result has been updated based on the pre-update context understanding result and the updated context understanding result.

If the experience location and the experience contents of the updated context understanding result do not have values indicating a void, the dialogue control unit 150 selects, as an utterance template candidate, data on an utterance template class including a question as an utterance category and an experienced person and an experience impression as focus items. If the experience location of the updated context understanding result has a value indicating a void, the dialogue control unit 150 selects, as an utterance template candidate, data on an utterance template class including a related question as an utterance category and an experience location as a focus item. If the experience contents of the updated context understanding result have a value indicating a void, the dialogue control unit 150 selects, as an utterance template candidate, data on an utterance template class including a related question as an utterance category and experience contents as a focus item.

As in (2-1), the dialogue control unit 150 may check whether the selected utterance template candidate has been used in past utterances, according to the utterance history database.

(2-6) In the case where the dialogue control unit 150 determines that the experience location of the context understanding result has been updated based on the pre-update context understanding result and the updated context understanding result, the dialogue control unit 150 using a degree of similarity calculated based on a match rate of the experience location or experience contents between the updated context understanding result and experience locations in data on an experience class included in the experience database, as character strings or strings of morphemes.

The dialogue control unit 150 selects, as an utterance template candidate, data on an utterance template class in which sympathy serves as an utterance category and an utterance template has supplementary fields for the experience location of a similar experience, the experience impression of a similar experience, and the reason for the experience impression of a similar experience.

As in (2-1), the dialogue control unit 150 may check whether the selected utterance template candidate has been used in past utterances, according to the utterance history database.

(2-7) In the case where the dialogue control unit 150 determines that the experience contents of the context understanding result have been updated based on the pre-update context understanding result and the updated context understanding result, the dialogue control unit 150 using a degree of similarity calculated based on a match rate of the experience location or experience contents between the updated context understanding result and experience locations in data on an experience class included in the experience database, as character strings or strings of morphemes.

The dialogue control unit 150 selects, as an utterance template candidate, data on an utterance template class in which sympathy serves as an utterance category and an utterance template has supplementary fields for the experience contents of a similar experience, the experience impression of a similar experience, and the reason for the experience impression of a similar experience.

As in (2-1), the dialogue control unit 150 may check whether the selected utterance template candidate has been used in past utterances, according to the utterance history database.

The processing of (2-1) to (2-7) may be performed in a predetermined order, for example, “(2-1)→(2-2)→(2-3)→(2-4)→(2-5)→(2-6)→(2-7)” based on the determination result of conditions for updating the context understanding result.

(3) The dialogue control unit 150 outputs the utterance template candidate. If the context understanding result specified in the processing of (1) includes two or more context items, the dialogue control unit 150 calculates priority that indicates the order of application of templates. The priority may be outputted with the utterance template candidate. The dialogue control unit 150 may output a list of utterance template candidates instead of the priority such that the order of candidates in the list corresponds to the priority.

A method for calculating the priority will be described below. For example, the dialogue control unit 150 calculates the priority such that an utterance template for generating an utterance by using a similar experience (that is, an utterance template including sympathy or a related question as an utterance category) is placed at a higher priority. Moreover, the dialogue control unit 150 calculates the priority according to the utterance history database such that an utterance template including a question as an utterance category and an utterance template including sympathy as an utterance category are alternately used as frequently as possible.

In S160, the utterance generating unit 160 receives, as inputs, the updated context understanding result recorded in the recording unit 190 and the similar experience and the utterance template candidate that are selected in S150, generates an output text, which indicates an utterance serving as a response to the input text, by using the updated context understanding result, the similar experience, and the utterance template candidate, and outputs the output text.

The generation of an utterance will be specifically described below.

(1) In the case where an utterance template candidate includes sympathy as an utterance category

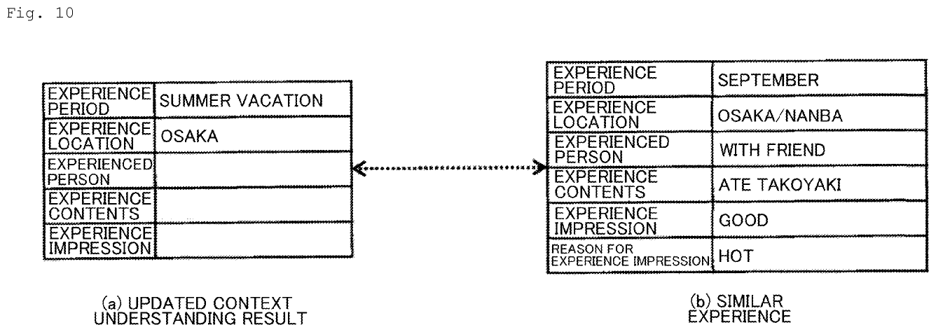

The utterance generating unit 160 fills the supplementary fields of the utterance template candidate based on the context items of a similar experience and the context items of the updated context understanding result, and then generates the output text. The utterance generating unit 160 sets the values of the context items corresponding to the supplementary fields of the utterance template candidate. For example, if the updated context understanding result is data in FIG. 10(a) and a similar experience is data in FIG. 10(b), the utterance generating unit 160 generates an utterance “I also ate takoyaki in Nanba. It tasted good because it was hot.” from an utterance template “I also [the experience contents of a similar experience] in [the experience location of a similar experience]. [The experience impression of a similar experience] because [the reason for the experience impression of a similar experience].”

Only in the case of a similar experience with a degree of similarity higher than or equal to the predetermined threshold, an utterance template candidate including prior sympathy as an utterance category may be used such that “I also [the experience contents of a similar experience] in [the experience location of a similar experience]. [The experience impression of a similar experience] because [the reason for the experience impression of a similar experience].” When an utterance is generated, the supplementary fields filled with the words of the context items as is may cause an unnatural sentence, for example, “I also ate takoyaki in Nanba. It tasted good because it was hot.” Thus, the sentence needs to be converted into a natural sentence, for example, “I also ate takoyaki in Nanba. It is hot and good, isn't it?” An example of the conversion is to produce conversion rules in advance from, for example, “because it was” to “it is” and “it tasted” to “it is.” A character string is replaced with another based on the conversion rules, thereby generating a natural sentence.

(2) In the case where an utterance template candidate includes a related question as an utterance category

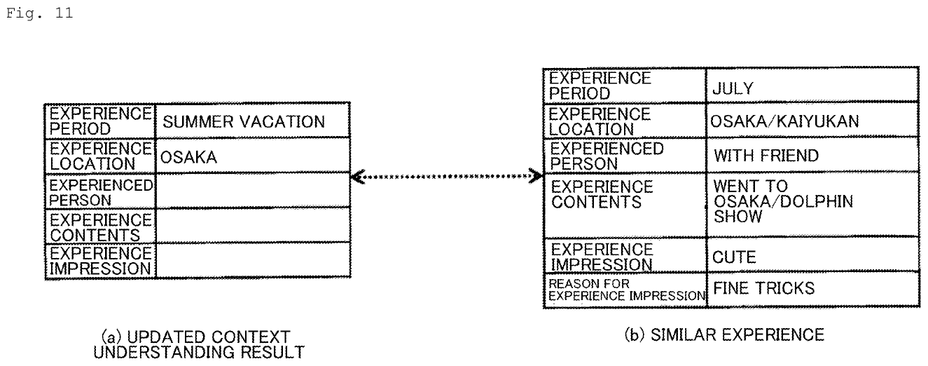

The utterance generating unit 160 fills the supplementary fields of the utterance template candidate based on the context items of a similar experience and the context items of the updated context understanding result, and then generates the output text. The utterance generating unit 160 sets the values of the context items corresponding to the supplementary fields of the utterance template candidate. For example, if the updated context understanding result is data in FIG. 11(a) and a similar experience is data in FIG. 11(b), the utterance generating unit 160 generates an utterance “I also went to Osaka in July. Did you go to Kaiyukan?” from an utterance template “I also [the experience contents of a similar experience] in [the experience period of a similar experience]. Did you go to [the experience location of a similar experience]?”

(3) In the case where an utterance template candidate includes a question or prior sympathy as an utterance category

If the utterance template candidate has supplementary fields, the utterance generating unit 160 fills the supplementary fields of the utterance template candidate based on the context items of a similar experience and the context items of the updated context understanding result, and then generates the output text. If the utterance template candidate does not have any supplementary fields, the utterance generating unit 160 uses the utterance template candidate as is as the output text without using a similar experience or the context understanding result.

In the case of (2-6) and (2-7) described in S150, the utterance generating unit 160 generates the output text from the utterance template candidate based on the experience location, an experience impression, and the reason for the experience impression of a similar experience.

In S170, the utterance output unit 170 receives, as an input, the output text generated in S160, generates an utterance (hereinafter referred to as output data) as a response to a user's utterance from the output text, outputs the utterance, and returns the control of the processing to S120. The utterance output unit 170 may output the output text as is as output data or output a speech (speech signal), which is generated from the output text by speech conversion, as output data. In other words, the output data may be outputted in any data format that humans can understand.

According to the embodiment of the present invention, an utterance can be generated based on data indicating the context of a dialogue.

### Additional Note

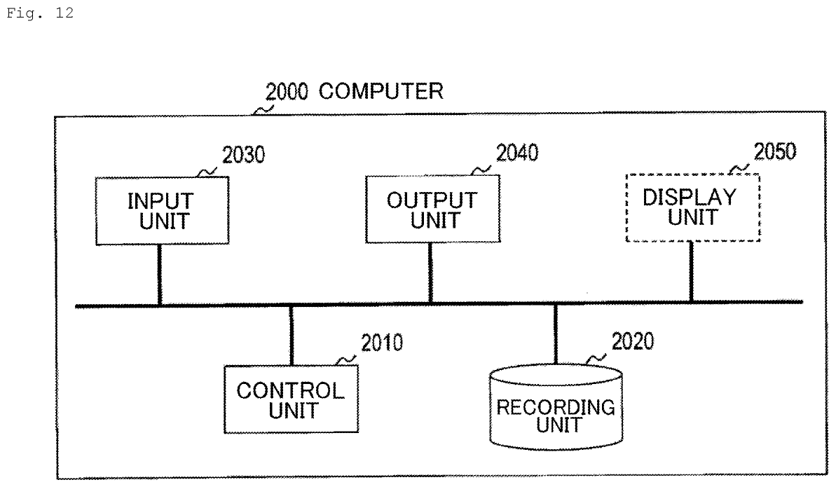

FIG. 12 illustrates an example of the functional configuration of a computer for implementing the foregoing devices. The processing of the foregoing devices can be performed by reading programs in a recording unit 2020 and operating, for example, a control unit 2010, an input unit 2030, and an output unit 2040, the programs causing the computer to act as the devices.

The device of the present invention includes, as separate hardware entities, an input unit to which a keyboard or the like is connectable, an output unit to which a liquid crystal display or the like is connectable, a communication unit to which a communication device (e.g., a communication cable) capable of communicating with the outside of the hardware entity is connectable, a CPU (Central Processing Unit, may be provided with cache memory or a register), RAM and ROM provided as memory, an external storage device provided as a hard disk, and a bus connecting the input unit, the output unit, the communication unit, the CPU, the RAM, the ROM, and external storage device so as to exchange data among the entities. The hardware entity may optionally include a device (drive) capable of reading and writing recording media such as a CD-ROM. A physical entity including such a hardware resource is, for example, a general purpose computer.

The external storage device of the hardware entity stores programs for implementing the foregoing functions and data necessary for the processing of the programs (the programs and the data may be stored in, for example, ROM that is a storage device specific for reading the programs, in addition to the external storage device). Data or the like obtained by the processing of the programs is properly stored in, for example, RAM or an external storage device.

In the hardware entity, the programs stored in the external storage device (or ROM) and data necessary for the processing of the programs are optionally read in the memory and are properly interpreted and processed in the CPU. Hence, the CPU implements predetermined functions (the components denoted as units or means).

The present invention is not limited to the foregoing embodiment and can be optionally changed within the scope of the present invention. The processing described in the embodiment is performed in time sequence in the order of description. Alternatively, the processing may be performed in parallel or separately according to the capacity of a processing unit or as necessary.

If the processing functions of the hardware entities (the devices of the present invention) described in the embodiment are implemented by a computer, the processing contents of functions to be provided for the hardware entities are described by a program. The program running on the computer implements the processing functions of the hardware entities.

The program that describes the processing contents can be recorded in a computer-readable recording medium. The computer-readable recording medium may be, for example, a magnetic recording device, an optical disk, a magneto-optic recording medium, or a semiconductor memory. Specifically, for example, a hard disk device, a flexible disk, or a magnetic tape can be used as a magnetic recording device, a DVD (Digital Versatile Disc), a DVD-RAM (Random Access Memory), a CD-ROM (Compact Disc Read Only Memory), or a CD-R (Recordable)/RW (ReWritable) can be used as an optical disk, a MO (Magneto-Optical disc) can be used as a magneto-optical recording medium, and an EEP-ROM (Electronically Erasable and Programmable-Read Only Memory) can be used as a semiconductor memory.

The program is distributed by, for example, selling, granting, or lending portable recording media such as a DVD and a CD-ROM for recording the program. Moreover, the program may be distributed such that the program stored in the storage device of a server computer is transferred from the server computer to another computer via a network.

For example, the computer for running the program initially stores, temporarily in the storage device of the computer, the program recorded in a portable recording medium or the program transferred from the server computer. When the processing is executed, the computer reads the program stored in the storage device and performs processing according to the read program. As another pattern of execution of the program, the computer may directly read the program from the portable recording medium and perform processing according to the program. Furthermore, the computer may perform processing according to the received program each time the program is transferred from the server computer to the computer. Alternatively, the processing may be executed by so-called ASP (Application Service Provider) service in which processing functions are implemented only by an instruction of execution and the acquisition of a result without transferring the program to the computer from the server computer. The program of the present embodiment includes information that is used for processing by an electronic calculator and is equivalent to the program (for example, data that is not a direct command to the computer but has the property of specifying the processing of the computer).

In the present embodiment, the hardware entity is configured such that the predetermined program runs on the computer. At least part of the processing contents may be implemented by hardware.

The description of the embodiment of the present invention is presented for the purpose of illustration and description. The description is not intended to be comprehensive or is not intended to limit the invention to a disclosed strict form. Modifications and variations can be made according to the foregoing teachings. The embodiment is selected and presented to provide the best illustration of the principle of the present invention and allow a person skilled in the art to apply the present invention suitably to considered actual use in various embodiments with additional modifications. All the modifications and variations are made within the scope of the present invention defined by the appended claims that are interpreted according to an impartially, legally, and fairly determined scope.

1. A device for generating an utterance, the device comprises a processor configured to execute a method comprising:
recording an experience database including data on an experience class and an utterance template database including data on an utterance template class, wherein the context class comprises a data structure including an experience period as an item indicating a period of an experience, an experience location as an item indicating a location of an experience, an experienced person as an item indicating a person who shares an experience, experience contents as an item indicating contents of an experience, and an experience impression as an item indicating an impression about an experience, an experience class is a data structure including an experience period, an experience location, an experienced person, experience contents, and an experience impression, which are items included in the context class (hereinafter referred to as context items), and an experience impression reason as an item indicating a ground for an impression about an experience, and an utterance template class is a data structure including information (hereinafter referred to as a template ID) for identifying a template (hereinafter referred to as an utterance template) used for generating an utterance, the utterance template, an utterance category indicating a type of the utterance template, and a context item indicating a focus of the utterance template (hereinafter referred to as a focus item);
generating a phrase set as a set of elements, in which data includes pairs of context items and values of the context items (hereinafter referred to as phrases) to be extracted from an input text indicating an utterance of a user;
generating, by using the phrase set, data on a context class indicating a context of a latest dialogue (hereinafter referred to as an updated context understanding result) from data on a context class indicating a context of a current dialogue (hereinafter referred to as a pre-update context understanding result);
selecting data on at least one experience class as a similar experience based on a degree of similarity calculated between the updated context understanding result and data on the experience class included in the experience database, and selecting, as an utterance template candidate, data on the utterance template class from the utterance template database by using the pre-update context understanding result and the updated context understanding result; and
generating an output text, which indicates an utterance serving as a response to the input text, by using the updated context understanding result, the similar experience, and the utterance template candidate.

2. The device according to claim 1, wherein,
when the selecting data on at least one experience class as a similar experience further comprises further determines that the experience impression of a context understanding result has been updated based on the pre-update context understanding result and the updated context understanding result, and
when the experience location of the updated context understanding result has a value indicating a void, the selecting data on at least one experience class as a similar experience further comprises selecting, as an utterance template candidate, data on an utterance template class including a question as an utterance category and an experience location as a focus item,
when the experience contents of the updated context understanding result have a value indicating a void, the selecting data on at least one experience class as a similar experience further comprises selecting, as an utterance template candidate, data on an utterance template class including a question as an utterance category and experience contents as a focus item, and
when the experience location and the experience contents of the updated context understanding result do not have values indicating a void, the selecting data on at least one experience class as a similar experience further comprises selecting, as an utterance template candidate, data on an utterance template class including sympathy as an utterance category and one of an experience location and experience contents as a focus item.

3. The device according to claim 1, wherein
when the selecting data on at least one experience class as a similar experience further determines that the experience contents of a context understanding result have been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience location of the updated context understanding result has a value indicating a void, the selecting data on at least one experience class as a similar experience further comprises selecting, as an utterance template candidate, data on an utterance template class including a question as an utterance category and an experience location as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience location and the experience impression of the updated context understanding result do not have values indicating a void, the selecting data on at least one experience class as a similar experience further comprises selecting, as an utterance template candidate, data on an utterance template class including sympathy as an utterance category and one of an experience location and an experience impression as a focus item.

4. The device according to claim 1, wherein
when the selecting data on at least one experience class as a similar experience further determines that the experience location of a context understanding result has been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience contents of the updated context understanding result have a value indicating a void, the selecting data on at least one experience class as a similar experience further comprises selecting, as an utterance template candidate, data on an utterance template class including a question as an utterance category and experience contents as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience contents and the experience impression of the updated context understanding result do not have values indicating a void, the selecting data on at least one experience class as a similar experience further comprises selecting, as an utterance template candidate, data on an utterance template class including sympathy as an utterance category and one of experience contents and an experience impression as a focus item.

5. The device according to claim 1, wherein
when the selecting data on at least one experience class as a similar experience further determines, that the experience period of a context understanding result has been updated based on the pre-update context understanding result and the updated context understanding result,
when the experience location and the experience contents of the updated context understanding result do not have values indicating a void, the selecting data on at least one experience class as a similar experience further comprises selecting, as an utterance template candidate, data on an utterance template class including a question as an utterance category and an experience period and an experience impression as focus items,
when the experience location of the updated context understanding result has a value indicating a void, the selecting data on at least one experience class as a similar experience further comprises selecting, as an utterance template candidate, data on an utterance template class including a related question as an utterance category and an experience location as a focus item, and
when the experience contents of the updated context understanding result have a value indicating a void, the selecting data on at least one experience class as a similar experience further comprises selecting, as an utterance template candidate, data on an utterance template class including a related question as an utterance category and experience contents as a focus item.

6. The device according to claim 1, wherein
the selecting data on at least one experience class as a similar experience further uses a degree of similarity calculated based on a match rate of an experience location or experience contents between the updated context understanding result and experience locations in data on an experience class included in the experience database, as character strings or strings of morphemes,
when the selecting data on at least one experience class as a similar experience further determines that the experience location of the context understanding result has been updated based on the pre-update context understanding result and the updated context understanding result, the selecting data on at least one experience class as a similar experience further comprises selecting, as an utterance template candidate, data on an utterance template class in which sympathy serves as an utterance category and an utterance template has supplementary fields for an experience location of a similar experience, an experience impression of a similar experience, and a reason for an experience impression of a similar experience, and
the generating the output text further generates the output text from the utterance template candidate based on the experience location, an experience impression, and a reason for the experience impression of the similar experience.

7. A computer implemented method for generating an utterance, comprising:
generating phrase set as a set of elements, in which data includes pairs of context items and values of the context items (hereinafter referred to as phrases) to be extracted from an input text indicating an utterance of a user, the method further comprising recording an experience database including data on an experience class and an utterance template database including data on an utterance template class, wherein the context class comprises a data structure including an experience period as an item indicating a period of an experience, an experience location as an item indicating a location of an experience, an experienced person as an item indicating a person who shares an experience, experience contents as an item indicating contents of an experience, and an experience impression as an item indicating an impression about an experience, an experience class is a data structure including an experience period, an experience location, an experienced person, experience contents, and an experience impression, which are items included in the context class (hereinafter referred to as context items), and an experience impression reason as an item indicating a ground for an impression about an experience, and an utterance template class is a data structure including information (hereinafter referred to as a template ID) for identifying a template (hereinafter referred to as an utterance template) used for generating an utterance, the utterance template, an utterance category indicating a type of the utterance template, and a context item indicating a focus of the utterance template (hereinafter referred to as a focus item);
generating, by using the phrase set, data on a context class indicating a context of a latest dialogue (hereinafter referred to as an updated context understanding result) from data on a context class indicating a context of a current dialogue (hereinafter referred to as a pre-update context understanding result);
selecting data on at least one experience class as a similar experience based on a degree of similarity calculated between the updated context understanding result and data on the experience class included in the experience database;
selecting, as an utterance template candidate, data on the utterance template class from the utterance template database by using the pre-update context understanding result and the updated context understanding result; and
generating an output text, which indicates an utterance serving as a response to the input text, by using the updated context understanding result, the similar experience, and the utterance template candidate.

8. A computer-readable non-transitory recording medium storing computer-executable program instructions that when executed by a processor cause a computer to execute a method comprising:
generating a phrase set as a set of elements, in which data includes pairs of context items and values of the context items (hereinafter referred to as phrases) to be extracted from an input text indicating an utterance of a user, the method further comprising recording an experience database including data on an experience class and an utterance template database including data on an utterance template class, wherein the context class comprises a data structure including an experience period as an item indicating a period of an experience, an experience location as an item indicating a location of an experience, an experienced person as an item indicating a person who shares an experience, experience contents as an item indicating contents of an experience, and an experience impression as an item indicating an impression about an experience, an experience class is a data structure including an experience period, an experience location, an experienced person, experience contents, and an experience impression, which are items included in the context class (hereinafter referred to as context items), and an experience impression reason as an item indicating a ground for an impression about an experience, and an utterance template class is a data structure including information (hereinafter referred to as a template ID) for identifying a template (hereinafter referred to as an utterance template) used for generating an utterance, the utterance template, an utterance category indicating a type of the utterance template, and a context item indicating a focus of the utterance template (hereinafter referred to as a focus item);
generating, by using the phrase set, data on a context class indicating a context of a latest dialogue (hereinafter referred to as an updated context understanding result) from data on a context class indicating a context of a current dialogue (hereinafter referred to as a pre-update context understanding result);
selecting data on at least one experience class as a similar experience based on a degree of similarity calculated between the updated context understanding result and data on the experience class included in the experience database;
selecting, as an utterance template candidate, data on the utterance template class from the utterance template database by using the pre-update context understanding result and the updated context understanding result; and
generating an output text, which indicates an utterance serving as a response to the input text, by using the updated context understanding result, the similar experience, and the utterance template candidate.

9. The computer implemented method according to claim 7, wherein,
when the selecting data on at least one experience class as a similar experience further comprises further determines that the experience impression of a context understanding result has been updated based on the pre-update context understanding result and the updated context understanding result, and when the experience location of the updated context understanding result has a value indicating a void, the selecting data on at least one experience class as a similar experience further comprises selecting, as an utterance template candidate, data on an utterance template class including a question as an utterance category and an experience location as a focus item,
when the experience contents of the updated context understanding result have a value indicating a void, the selecting data on at least one experience class as a similar experience further comprises selecting, as an utterance template candidate, data on an utterance template class including a question as an utterance category and experience contents as a focus item, and
when the experience location and the experience contents of the updated context understanding result do not have values indicating a void, the selecting data on at least one experience class as a similar experience further comprises selecting, as an utterance template candidate, data on an utterance template class including sympathy as an utterance category and one of an experience location and experience contents as a focus item.

10. The computer implemented method according to claim 7, wherein, when the selecting data on at least one experience class as a similar experience further determines that the experience contents of a context understanding result have been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience location of the updated context understanding result has a value indicating a void, the selecting data on at least one experience class as a similar experience further comprises selecting, as an utterance template candidate, data on an utterance template class including a question as an utterance category and an experience location as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience location and the experience impression of the updated context understanding result do not have values indicating a void, the selecting data on at least one experience class as a similar experience further comprises selecting, as an utterance template candidate, data on an utterance template class including sympathy as an utterance category and one of an experience location and an experience impression as a focus item.

11. The computer implemented method according to claim 7, wherein,
when the selecting data on at least one experience class as a similar experience further determines that the experience location of a context understanding result has been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience contents of the updated context understanding result have a value indicating a void, the selecting data on at least one experience class as a similar experience further comprises selecting, as an utterance template candidate, data on an utterance template class including a question as an utterance category and experience contents as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience contents and the experience impression of the updated context understanding result do not have values indicating a void, the selecting data on at least one experience class as a similar experience further comprises selecting, as an utterance template candidate, data on an utterance template class including sympathy as an utterance category and one of experience contents and an experience impression as a focus item.

12. The computer implemented method according to claim 7, wherein
when the selecting data on at least one experience class as a similar experience further determines, that the experience period of a context understanding result has been updated based on the pre-update context understanding result and the updated context understanding result,
when the experience location and the experience contents of the updated context understanding result do not have values indicating a void, the selecting data on at least one experience class as a similar experience further comprises selecting, as an utterance template candidate, data on an utterance template class including a question as an utterance category and an experience period and an experience impression as focus items,
when the experience location of the updated context understanding result has a value indicating a void, the selecting data on at least one experience class as a similar experience further comprises selecting, as an utterance template candidate, data on an utterance template class including a related question as an utterance category and an experience location as a focus item, and
when the experience contents of the updated context understanding result have a value indicating a void, the selecting data on at least one experience class as a similar experience further comprises selecting, as an utterance template candidate, data on an utterance template class including a related question as an utterance category and experience contents as a focus item.

13. The computer implemented method according to claim 7, wherein
the selecting data on at least one experience class as a similar experience further uses a degree of similarity calculated based on a match rate of an experience location or experience contents between the updated context understanding result and experience locations in data on an experience class included in the experience database, as character strings or strings of morphemes,
when the selecting data on at least one experience class as a similar experience further determines that the experience location of the context understanding result has been updated based on the pre-update context understanding result and the updated context understanding result, the selecting data on at least one experience class as a similar experience further comprises selecting, as an utterance template candidate, data on an utterance template class in which sympathy serves as an utterance category and an utterance template has supplementary fields for an experience location of a similar experience, an experience impression of a similar experience, and a reason for an experience impression of a similar experience, and
the generating the output text further generates the output text from the utterance template candidate based on the experience location, an experience impression, and a reason for the experience impression of the similar experience.

14. The computer-readable non-transitory recording medium according to claim 8, wherein,
when the selecting data on at least one experience class as a similar experience further comprises further determines that the experience impression of a context understanding result has been updated based on the pre-update context understanding result and the updated context understanding result, and when the experience location of the updated context understanding result has a value indicating a void, the selecting data on at least one experience class as a similar experience further comprises selecting, as an utterance template candidate, data on an utterance template class including a question as an utterance category and an experience location as a focus item,
when the experience contents of the updated context understanding result have a value indicating a void, the selecting data on at least one experience class as a similar experience further comprises selecting, as an utterance template candidate, data on an utterance template class including a question as an utterance category and experience contents as a focus item, and
when the experience location and the experience contents of the updated context understanding result do not have values indicating a void, the selecting data on at least one experience class as a similar experience further comprises selecting, as an utterance template candidate, data on an utterance template class including sympathy as an utterance category and one of an experience location and experience contents as a focus item.

15. The computer-readable non-transitory recording medium according to claim 8, wherein, when the selecting data on at least one experience class as a similar experience further determines that the experience contents of a context understanding result have been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience location of the updated context understanding result has a value indicating a void, the selecting data on at least one experience class as a similar experience further comprises selecting, as an utterance template candidate, data on an utterance template class including a question as an utterance category and an experience location as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience location and the experience impression of the updated context understanding result do not have values indicating a void, the selecting data on at least one experience class as a similar experience further comprises selecting, as an utterance template candidate, data on an utterance template class including sympathy as an utterance category and one of an experience location and an experience impression as a focus item.

16. The computer-readable non-transitory recording medium according to claim 8, wherein,
when the selecting data on at least one experience class as a similar experience further determines that the experience location of a context understanding result has been updated based on the pre-update context understanding result and the updated context understanding result,
when a degree of similarity of a similar experience is higher than or equal to a predetermined threshold, the selecting data on at least one experience class as a similar experience further comprises selecting, as an utterance template candidate, data on an utterance template class including prior sympathy as an utterance category,
otherwise when the experience contents of the updated context understanding result have a value indicating a void, the selecting data on at least one experience class as a similar experience further comprises selecting, as an utterance template candidate, data on an utterance template class including a question as an utterance category and experience contents as a focus item, when the experience impression of the updated context understanding result has a value indicating a void, the selecting data on at least one experience class as a similar experience further comprises selecting, as an utterance template candidate, data on an utterance template class including a question as an utterance category and an experience impression as a focus item, and when the experience contents and the experience impression of the updated context understanding result do not have values indicating a void, the selecting data on at least one experience class as a similar experience further comprises selecting, as an utterance template candidate, data on an utterance template class including sympathy as an utterance category and one of experience contents and an experience impression as a focus item.

17. The computer-readable non-transitory recording medium according to claim 8, wherein
when the selecting data on at least one experience class as a similar experience further determines, that the experience period of a context understanding result has been updated based on the pre-update context understanding result and the updated context understanding result,
when the experience location and the experience contents of the updated context understanding result do not have values indicating a void, the selecting data on at least one experience class as a similar experience further comprises selecting, as an utterance template candidate, data on an utterance template class including a question as an utterance category and an experience period and an experience impression as focus items,
when the experience location of the updated context understanding result has a value indicating a void, the selecting data on at least one experience class as a similar experience further comprises selecting, as an utterance template candidate, data on an utterance template class including a related question as an utterance category and an experience location as a focus item, and
when the experience contents of the updated context understanding result have a value indicating a void, the selecting data on at least one experience class as a similar experience further comprises selecting, as an utterance template candidate, data on an utterance template class including a related question as an utterance category and experience contents as a focus item.

18. The computer-readable non-transitory recording medium according to claim 8, wherein
the selecting data on at least one experience class as a similar experience further uses a degree of similarity calculated based on a match rate of an experience location or experience contents between the updated context understanding result and experience locations in data on an experience class included in the experience database, as character strings or strings of morphemes,
when the selecting data on at least one experience class as a similar experience further determines that the experience location of the context understanding result has been updated based on the pre-update context understanding result and the updated context understanding result, the selecting data on at least one experience class as a similar experience further comprises selecting, as an utterance template candidate, data on an utterance template class in which sympathy serves as an utterance category and an utterance template has supplementary fields for an experience location of a similar experience, an experience impression of a similar experience, and a reason for an experience impression of a similar experience, and
the generating the output text further generates the output text from the utterance template candidate based on the experience location, an experience impression, and a reason for the experience impression of the similar experience.
